(19) United States
(12) Patent Application Publication
(10) Pub. No.: US 2017/0277021 A1
(43) Pub. Date: Sep. 28, 2017

(54) SMART HYBRID SELFIE CANE

(71) Applicants: Amina Sultan, Frisco, TX (US); Ali Arwani, Frisco, TX (US); Iman Arwani, Frisco, TX (US)

(72) Inventors: Amina Sultan, Frisco, TX (US); Ali Arwani, Frisco, TX (US); Iman Arwani, Frisco, TX (US)

(21) Appl. No.: 15/469,051

(22) Filed: Mar. 24, 2017

Related U.S. Application Data
(60) Provisional application No. 62/313,518, filed on Mar. 25, 2016.

(51) Int. Cl. G03B 17/56; A63C 11/22; A45B 9/02; A45B 3/00; A45B 1/00

(52) U.S. Cl. CPC G03B 17/561; A45B 3/00; A45B 1/00; A45B 9/02; A63C 11/228; A45B 2200/055; A45B 2009/007

(57) ABSTRACT

A mechanism is described for facilitating a smart hybrid selfie cane. An apparatus of embodiments, as described herein, includes a hybrid selfie cane to serve as at least one of a selfie stick and a cane, wherein the hybrid selfie cane includes the selfie stick coupled to the cane.

### CLAIM OF PRIORITY

This application claims priority to and the benefit of U.S. Provisional Patent Application No. 62/313,518, entitled SMART HYBRID SELFIE CANE, by Sultan, et al., filed Mar. 25, 2016, where all the contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

Embodiments described herein generally relate to devices. More particularly, embodiments relate to a smart hybrid selfie cane.

### BACKGROUND

With the growing use of mobile computing devices, selfie sticks are becoming increasingly popular to provide the users the ease with which they can take their own pictures using mobile device cameras. However, in many instances, such as when hiking or climbing uphill, etc., users (e.g., hikers, tourists, etc.) often need to rely on their walking sticks or canes to have sufficient support to perform any relevant activities, such as hiking. Conventional selfie sticks and walking canes are severely limited in their functions or operations and thus, users are forced to carry multiple devices to perform their respective functions.

### BRIEF DESCRIPTION OF THE DRAWINGS

Embodiments are illustrated by way of example, and not by way of limitation, in the figures of the accompanying drawings in which like reference numerals refer to similar elements. It is to be noted, however, that the appended drawings illustrate only typical embodiments and are therefore not to be considered limiting of its scope, for the drawings may illustrate other equally effective embodiments.

FIG. 1A illustrates a hybrid selfie cane according to one embodiment.

FIGS. 1B and 1C illustrate a hybrid selfie cane having a selfie stick and an extended cane with a handle according to one embodiment.

FIGS. 2A and 2B illustrate a hybrid selfie cane shortening or extending to serve a selfie stick or a cane, respectively, according to one embodiment.

FIGS. 3A and 3B illustrate a hybrid selfie cane shortening or extending to serve as a selfie stick or a cane, respectively, according to one embodiment.

FIG. 3C illustrates a hybrid selfie cane turning into a tripod.

FIGS. 4A, 4B and 4C illustrate a hybrid selfie cane having a selfie stick with a handle according to one embodiment.

FIG. 5 is a computing system capable of employing one or more embodiments.

### DESCRIPTION

Embodiments provide for a novel technique to combine a multiple device into a single device that is capable of performing multiple functions or operations. In one embodiment, a novel and innovative selfie cane is provided to provide both the functionalities of a selfie stick and a walking/hiking cane (also referred to as “stem”, “walking stick”, “ski pole”, “pole”, or simply “cane”). For example, as illustrated with respect to the subsequent figures, a selfie cane is shown as a hybrid device to incorporate both a selfie stick and a walking cane so that the user may take own pictures and find support for waking, hiking, etc. using the single novel selfie cane.

Although various illustrates are provided and discussed throughout this document, it is contemplated that embodiments are limited as such. For example, the stem or cane part of the novel hybrid selfie cane may be prolonged or shortened in number of ways to suit the user of this selfie cane, such as in accordance with the height of the person. For example, in one embodiment, the stem of the selfie can may be pipe-like where it is push inwards or pulled outwards to adjust the length of the stem to suit the height of the person. In another embodiment, the stem may be folded such that multiple segments of the stem may be folded in or out to make the stem shorter or longer as necessitated or desired by the user. In yet another embodiment, the stem may include multiple segments where each segment may be separated from other segments. In yet another embodiment, a selfie stick may be attached to a regular sized stem or cane to form the hybrid selfie cane.

Conventional techniques require the user to carry separate devices, such as both a selfie stick and a walking case, to separately perform their respective functions, such as taking pictures and finding support for walking.

This novel selfie cane is a hybrid device that allows for maximum use, ranging from taking pictures, finding support for walking, etc., without having to carry multiple devices or any other extra luggage, such as device carrying bags, etc.

Throughout this document, terms like “logic”, “component”, “module”, “framework”, “engine”, “mechanism”, “technique”, and/or the like, may be referenced interchangeably and include, by way of example, software, hardware, and/or any combination of software and hardware, such as firmware. Throughout this document, terms like “person”, “user”, “hiker”, “walker”, “human”, “man”, “woman”, “boy”, “girl”, “end-user”, and/or the like, may be referenced interchangeably. Further, any use of a particular brand, word, term, phrase, name, acronym, or the like, such as “user”, “hiker”, “camera”, “selfie”, “picture”, “photo”, “stick”, “cane”, “walking”, “hiking”, “climbing”, “wired”, “wireless”, “computing device”, “smartphone”, “tablet computer”, “software application”, “social/business networking site”, “website” or “site”, and/or the like, should not be read to limit embodiments to software or devices that carry that label in products or in literature external to this document.

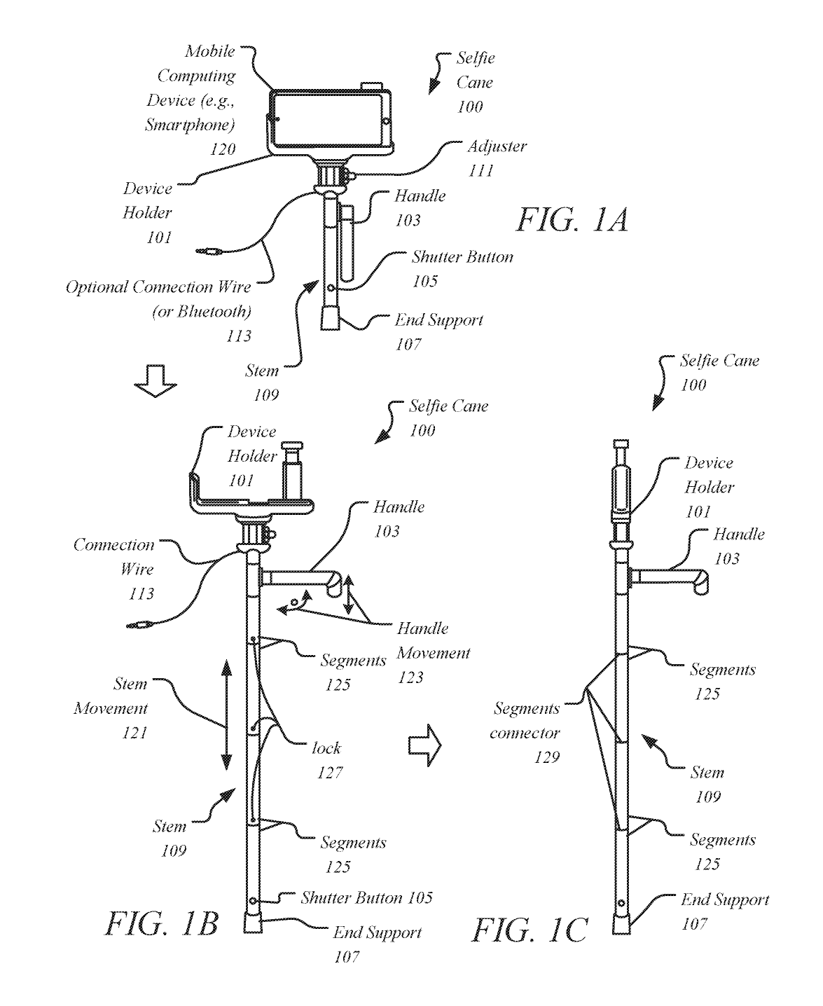

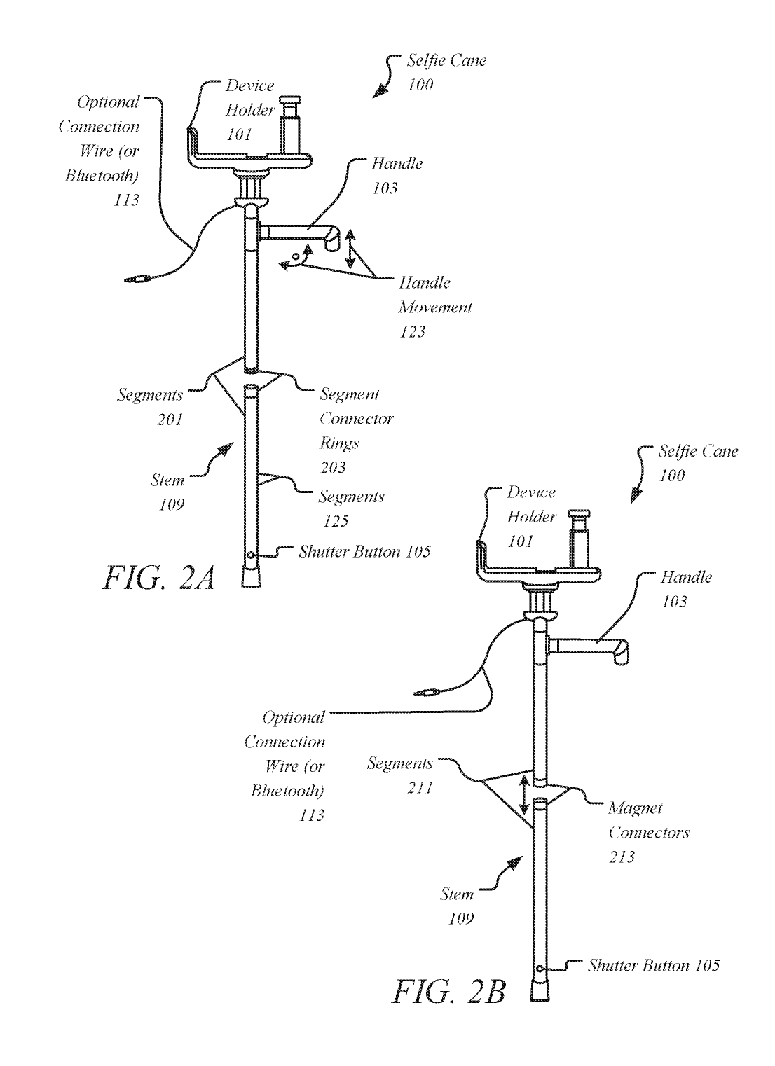

FIG. 1A illustrates a selfie cane 100 according to one embodiment. In this illustrated embodiment, novel selfie cane 100 includes device holder 101 that is capable of holding a computing device 120 (e.g., smartphone, tablet computer, etc.) having a camera capable of taking pictures, etc., using connection wire 113 to connect computing device 120 with selfie cane 100 and allowing communication with shutter button 105 capable of being used for clicked or touched for facilitating taking of pictures, etc.

As illustrated, selfie cane 100 includes adjuster 111 located somewhere between device holder 101 and stem 109, where adjuster 111 may be used to prolong or shorten stem 109 as desired or necessitated by a user so that selfie can 100 may be used as a cane for walking, hiking, climbing, etc. For example, adjuster 111 may include a knob that may be manually turned, clockwise or counter-clockwise, or a button that can be manually or digitally pushed, in or out, or digitally touched or clicked, etc., to manually or automatically adjust stem 109 to a particular length to use selfie cane 100 as a selfie stick for taking pictures or walking cane for finding support for walking, etc., as desired or necessitated by the user.

Now referring to FIG. 1B, as further illustrated, handle 103 (shown as closed in FIG. 1A) may be opened (as shown in FIG. 1B) to be used for support for walking, such as the user may choose to place their hand on handle 103 to find support during waking, climbing, etc., as is the case when a cane is used for walking, etc. For example, handle 103 may be closed or partially opened or completely opened as shown by handle movement 123. Further, for example, stem 109 may include any number and size and type of segments 125 that are used into extending or contracting step 109 for various purposes, such as using as a selfie stick for taking own pictures, a walking cane for waking, etc.

FIGS. 1A and 1B further illustrate end support 107 which is used for providing sufficient bottom support when using selfie cane 100 as a walking cane for walking, climbing, hiking, etc. Further, in one embodiment, segments 125 may be connected with each other using locks 127, as illustrated in FIG. 1B, and/or joined with each other using segment connectors 129, as illustrated in FIG. 1C. In one embodiment, stem 109 may be extended or reduced in size, as shown by stem movement 121, by simply manually extending or contracting or twisting stem 109 or digitally pushing a button on stem 109, etc. FIG. 1B illustrates a front or back view of a selfie cane 100 according to one embodiment, where FIG. 1C illustrates a side view of a selfie cane 100 according to one embodiment.

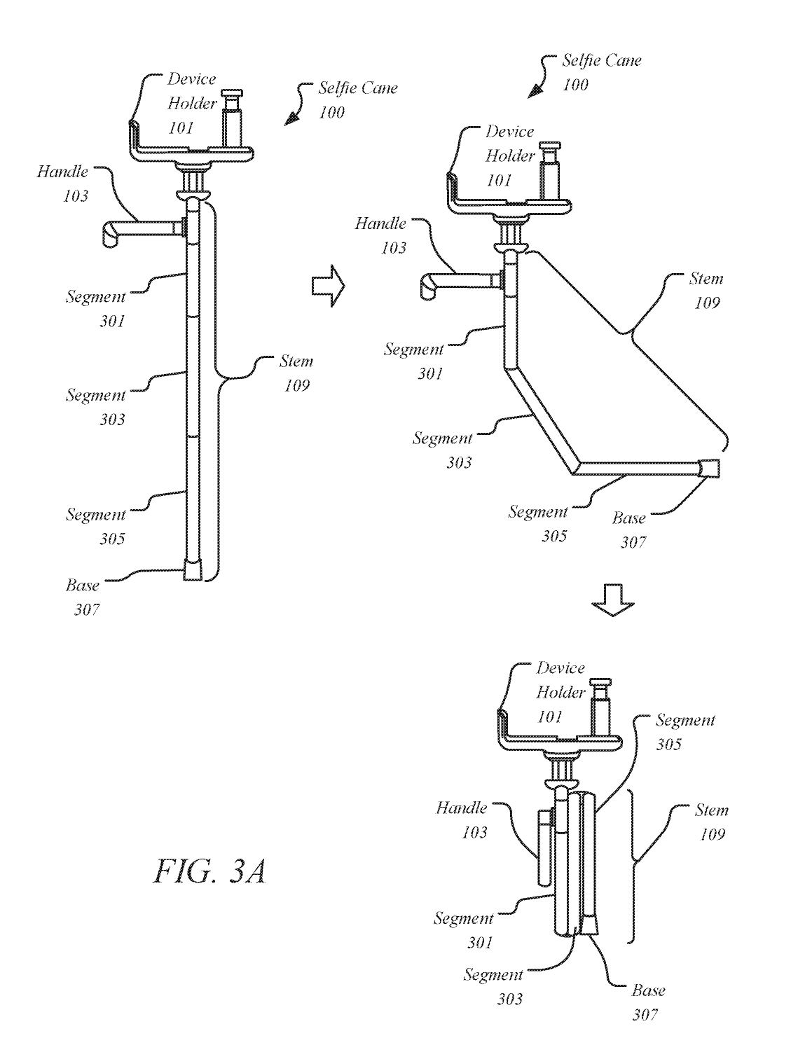

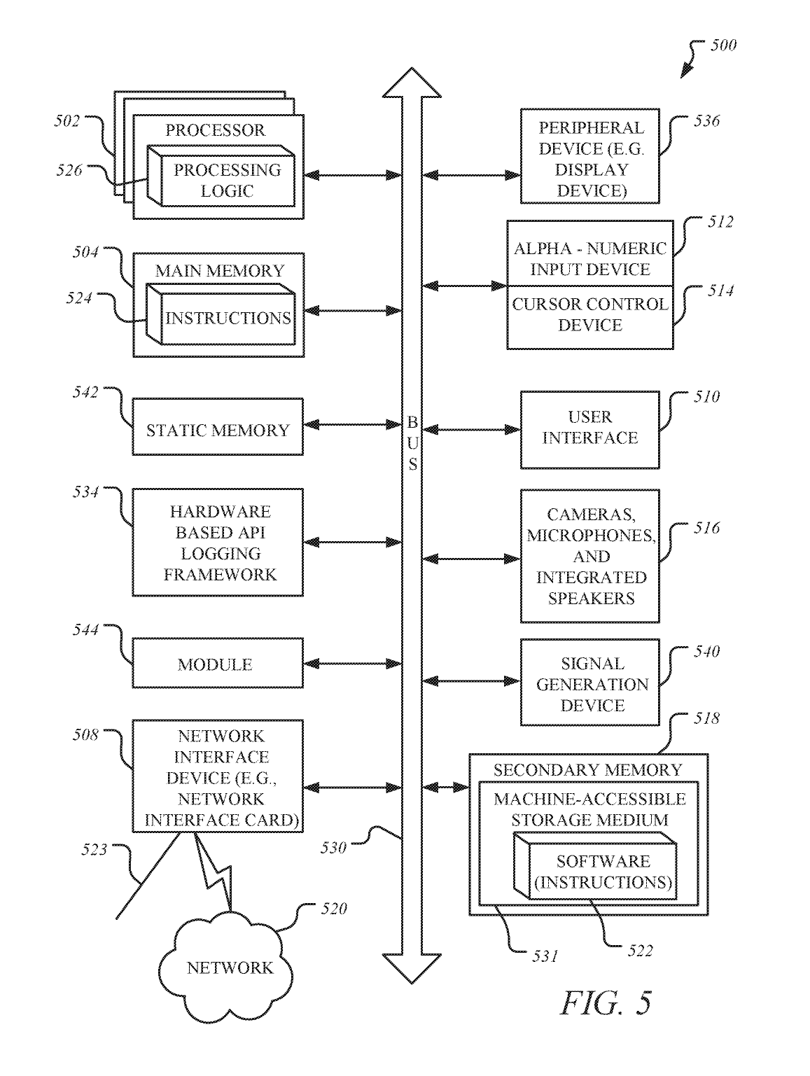

FIG. 2A illustrates a selfie cane 100 according to one embodiment. In FIGS. 1A, 1B and 1C, segments 125 may be continuously or permanently joined and held together using locks 127 and/or segment connectors 129, and/or the like. In this illustrated embodiment of FIG. 2A, segments 201 may not be continuously or permanently joined or held together and that they may be connected or twisted in with each other using segment connector rings 203, as necessitated or desired by the user. Although this illustration shows wire 113 to connect a camera, smartphone, tablet computer, etc., with device holder 101, it is contemplated that embodiments are not limited as such and that the communication between camera/smartphone, etc., and device holder 101 may be wireless over a network, such as network 520 of FIG. 5, such as proximity network, Bluetooth, the Internet, etc.

FIG. 2B illustrates a selfie cane 100 according to one embodiment. In this illustrated embodiment of FIG. 2B, segments 211 may not be continuously or permanently joined or held together and that they may be connected or snapped with each other using magnets or magnet connectors 213, as necessitated or desired by the user. Although this illustration shows wire 113 to connect a camera, smartphone, tablet computer, etc., with device holder 101, it is contemplated that embodiments are not limited as such and that the communication between camera/smartphone, etc., and device holder 101 may be wireless over a network, such as network 520 of FIG. 5, such as proximity network, Bluetooth, the Internet, etc.

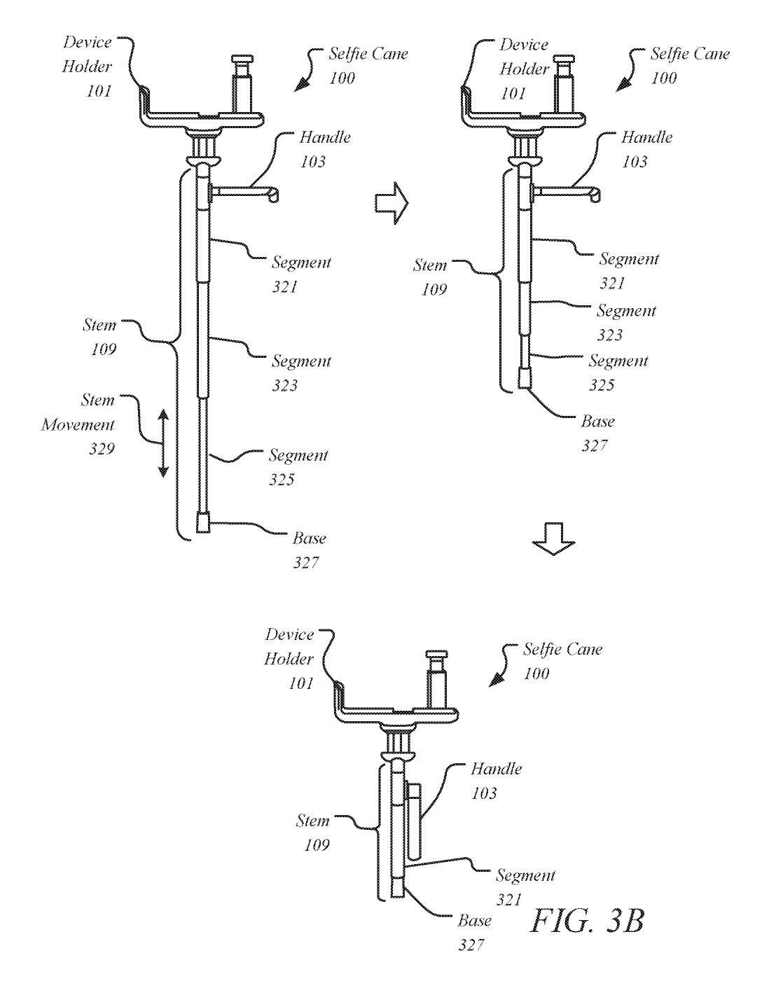

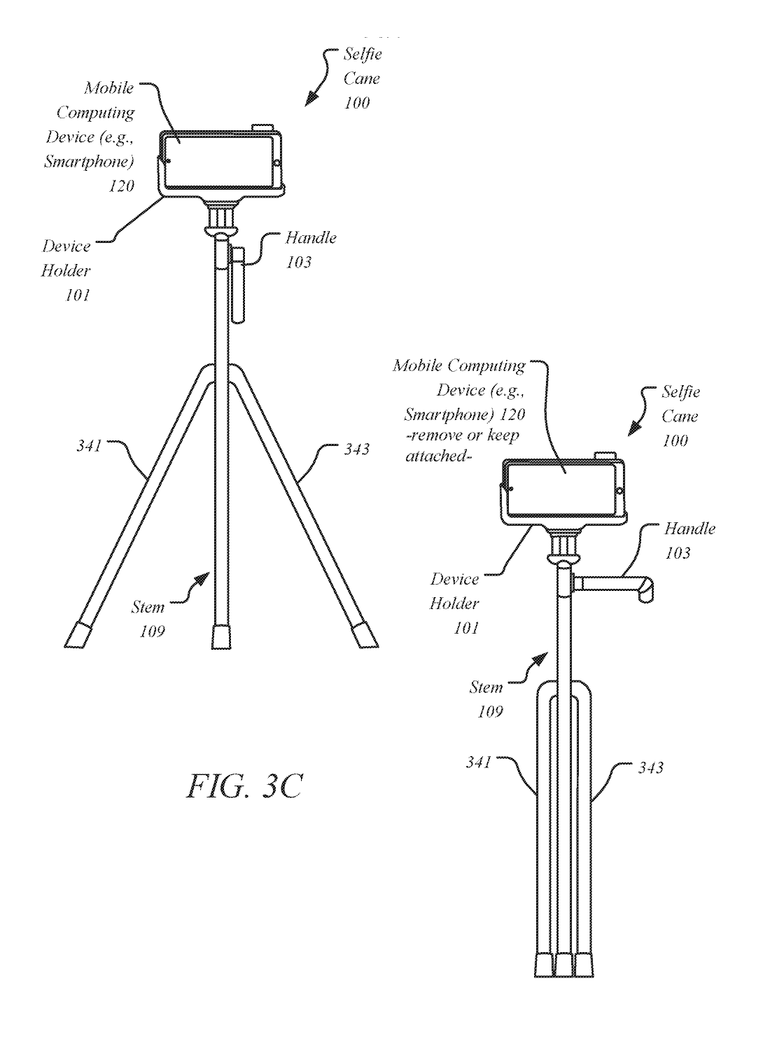

FIG. 3A illustrates a selfie cane 100 according to one embodiment. As illustrated, stem 109 may be folded in or folded out, segment by segment 301, 303, 305, wherein selfie cane 100 further includes device holder 101 and handle 103. As discussed above with reference to earlier Figures, embodiments are not limited to any particular manner of prolonging or shortening stem 109 into using selfie cane 100 as a cane or a selfie stick, respectively. For example, in this illustrated embodiment, stem may be divided (but not necessarily separated) into a number of segments, such as segment 301, 303, 305, with base 307 (such as made with rubber or plastic or metal, etc.) at the bottom. As illustrated, in this embodiment, stem 109 may be folded into reduced selfie cane 100 to serve as a small practical selfie stick which is also small enough to be put into a backpack, a bag, a purse, etc., or stowed under bed or other piece of furniture, etc. It is further contemplated that segments 301, 303, 305 of stem 109 may be unfolded into an expanded selfie cane 100 that can be used as a walking/hiking cane, using handle 103, or as a tripod stand, as illustrated in FIG. 3C, for taking pictures.

FIG. 3B illustrates a selfie cane 100 according to one embodiment. As illustrated, stem 109 may be pushed in or pulled out, segment by segment 321, 323, 325, wherein selfie cane 100 further includes device holder 101 and handle 103. As discussed above with reference to earlier Figures, embodiments are not limited to any particular manner of prolonging or shortening stem 109 into using selfie cane 100 as a cane or a selfie stick, respectively. For example, in this illustrated embodiment, stem may be divided (but not necessarily separated) into a number of segments, such as segment 321, 323, 325, with small base 327 (such as made with rubber or plastic or metal, etc.) at the bottom. As illustrated, in this embodiment, stem 109 may be pushed in such that reducing selfie cane 100 serves as a small practical selfie stick which is also small enough to be put into a backpack, a bag, a purse, etc., or stowed under bed or other piece of furniture, etc. It is further contemplated that segments 321, 323, 325 of stem 109 may be pulled out such that a bigger selfie cane 100 serves as a walking/hiking cane, using handle 103, or as a tripod stand, as illustrated in FIG. 3C, for taking pictures.

FIG. 3C illustrates a selfie cane 100 according to one embodiment. As illustrated, selfie can 100 may be transformed into a tripod, such as having stem 109 and other associated segments 341, 343. As illustrated, when segments 341, 343 are separated from stem 109, selfie cane 100 turns into tripod to be used for taking pictures with a solid standing base having placed smart/camera device 120 in holding device 101 and handle 103 folded in. As further illustrated, segments 341, 343 may be folded in with stem 109 to turn selfie cane 100 to a walking/hiking cane with handle 103 folded out for support.

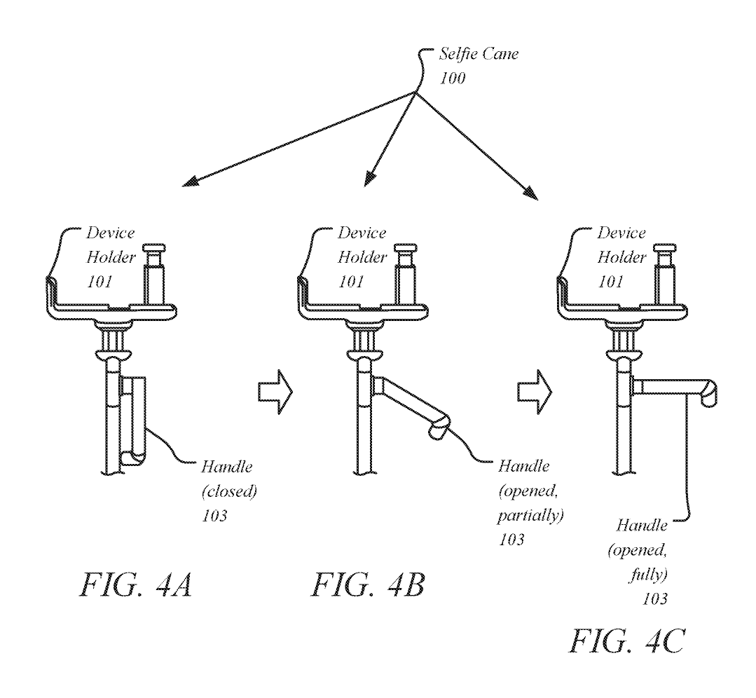

FIGS. 4A, 4B and 4C illustrate a selfie cane 100 according to one embodiment. The illustrated embodiments of FIGS. 4A, 4B and 4C illustrate the movement and the use of handle 103 for the purposes of offering support to the human hand, arm, etc., for walking, hiking, climbing, etc. For example, in FIG. 4A, handle 103 is shown as being closed so it remains out of the way when selfie cane 100 may be used as a selfie stick for taking photographs. However, when needed, as shown in FIG. 4B, handle 103 may be moved upwards (shown as partially opened) until handle 103 is completely opened as shown in FIG. 4C and may then be used for using selfie cane 100 as a walking cane for walking, climbing, hiking, etc.

It is contemplated that embodiments are not limited to any particular or shown size or type or shape or location of handle 103 and that any number and type and shape and location of handles may be used based on various factors, such as convenience, aesthetics, design, logistics, etc. For example, handle 103 may be a soft handle of cloth and/or leather, hard handle of plastic and/or metal, etc., or of an entirely different shape or size or having a varying opening mechanism (such as in/out instead of the illustrated up/down) or in some cases, handle 103 may include multiple handles.

Further, it is contemplated that computing device 120 is not limited to an any particular type or brand or size of device, such as smartphones, tablet computers, digital cameras, personal digital assistants (PDAs), laptop computers, e-readers, wearable smart devices, media players, Internet of Things (IoT) devices, etc., may be used and communicated over any number and type of communication medium(s), such as one or more networks (e.g., a cloud network, a proximity network, an intranet, Bluetooth, the Internet, etc.).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “website”, “site”, “program”, “software program”, “code”, “software code”, “package”, and “software package” may be used interchangeably throughout this document. Similarly, terms like “job”, “input”, “request” and “message” may be used interchangeably throughout this document.

FIG. 5 illustrates a diagrammatic representation of a machine 500 in the exemplary form of a computer system, in accordance with one embodiment, within which a set of instructions, for causing machine 500 to perform any one or more of the methodologies discussed herein, may be executed. Machine 500 may be the same as or similar to or contained within computing device 120 and/or used as part of selfie cane 100, such as smart selfie cane 100, of the preceding FIGS. 1A-4C to be used to perform or execute one or more methodologies discussed throughout this document. In alternative embodiments, machine 500 may be connected (e.g., networked) to other machines either directly, such as via media slot or over a network, such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes one or more processors 502, a main memory 504 (e.g., read-only memory (ROM), flash memory, dynamic random access memory (DRAM) such as synchronous DRAM (SDRAM) or Rambus DRAM (RDRAM), etc., static memory 542, such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes instructions 524 (such as software 522 on which is stored one or more sets of instructions 524 embodying any one or more of the methodologies or functions of reverse shopping mechanism 110 of computing device 100 of FIG. 1 and other figures described herein) which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of reverse shopping mechanism 110 of computing device 100 of FIG. 1 and other figures discussed herein.

The computer system 500 may further include a network interface device 508, such as a network interface card (NIC). The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), a signal generation device 540 (e.g., an integrated speaker), and other devices 516 like cameras, microphones, integrated speakers, etc. The computer system 500 may further include peripheral device 536 (e.g., wireless or wired communication devices, memory devices, storage devices, audio processing devices, video processing devices, display devices, etc.). The computer system 500 may further include a hardware-based application programming interface logging framework 534 capable of executing incoming requests for services and emitting execution data responsive to the fulfillment of such incoming requests.

Network interface device 508 may also include, for example, a wired network interface to communicate with remote devices via network cable 523, which may be, for example, an Ethernet cable, a coaxial cable, a fiber optic cable, a serial cable, a parallel cable, etc. Network interface device 508 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface device 508 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

The secondary memory 518 may include a machine-readable storage medium (or more specifically a machine-accessible storage medium) 531 on which is stored one or more sets of instructions (e.g., software 522) embodying any one or more of the methodologies or functions of reverse shopping mechanism 110 of FIG. 1 and other figures described herein. The software 522 may also reside, completely or at least partially, within the main memory 504, such as instructions 524, and/or within the processor 502 during execution thereof by the computer system 500, the main memory 504 and the processor 502 also constituting machine-readable storage media. The software 522 may further be transmitted or received over network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

Modules 544 relating to and/or include components and other features described herein (for example in relation to reverse shopping mechanism 110 of computing device 100 as described with reference to FIG. 1) can be implemented as discrete hardware components or integrated in the functionality of hardware components such as ASICS, FPGAs, DSPs or similar devices. In addition, modules 544 can be implemented as firmware or functional circuitry within hardware devices. Further, modules 544 can be implemented in any combination hardware devices and software components.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. An apparatus comprising:
a hybrid selfie cane to serve as at least one of a selfie stick and a cane, wherein the hybrid selfie cane includes the selfie stick coupled to the cane.

2. The apparatus of claim 1, wherein the hybrid selfie cane comprises a device holder to hold a smart device having a camera capable of taking images including still images or videos, and wherein the hybrid selfie cane when serving as the selfie stick holds the smart device to facilitate taking images, and wherein the selfie cane when serving as the cane offers support for a user to perform at least one of walking, hiking, climbing, and skiing using the hybrid selfie cane.

3. The apparatus of claim 1, wherein the hybrid selfie cane comprises a stem having multiple segments, wherein the multiple segments are capable of being folded-in to turn the hybrid selfie cane to be used as the selfie stick or folded-out to turn the hybrid selfie cane to be used as the cane.

4. The apparatus of claim 3, wherein the multiple segments are capable of being pushed into each other to turn the hybrid selfie cane to be used as the selfie stick or pulled out of each other to turn the hybrid selfie cane to be used as the cane.

5. The apparatus of claim 3, wherein the multiple segments possess fitting rings or magnets at one or more ends, wherein the multiple segments are joined together or separated from each other using the fitting rings or the magnets to turn the hybrid selfie cane to be used as the selfie stick or pulled out of each other to turn the hybrid selfie cane to be used as the cane, respectively.

6. The apparatus of claim 3, wherein the hybrid selfie cane further comprises one or more minor stems coupled to in parallel with the stem, wherein the stem and the minor stems are pulled apart from each other to turn into a tripod to support the hybrid selfie cane.

7. A hybrid selfie cane comprising:
a selfie stick coupled to a cane, wherein the hybrid selfie cane serves as the selfie stick or the cane.

8. The selfie cane of claim 7, wherein the hybrid selfie cane comprises a device holder to hold a smart device having a camera capable of taking images including still images or videos, and wherein the hybrid selfie cane when serving as the selfie stick holds the smart device to facilitate taking images, and wherein the selfie cane when serving as the cane offers support for a user to perform at least one of walking, hiking, climbing, and skiing using the hybrid selfie cane.

9. The selfie cane of claim 7, wherein the hybrid selfie cane comprises a stem having multiple segments, wherein the multiple segments are capable of being folded-in to turn the hybrid selfie cane to be used as the selfie stick or folded-out to turn the hybrid selfie cane to be used as the cane.

10. The selfie cane of claim 9, wherein the multiple segments are capable of being pushed into each other to turn the hybrid selfie cane to be used as the selfie stick or pulled out of each other to turn the hybrid selfie cane to be used as the cane.

11. The selfie cane of claim 9, wherein the multiple segments possess fitting rings or magnets at one or more ends, wherein the multiple segments are joined together or separated from each other using the fitting rings or the magnets to turn the hybrid selfie cane to be used as the selfie stick or pulled out of each other to turn the hybrid selfie cane to be used as the cane, respectively.

12. The selfie cane of claim 9, wherein the hybrid selfie cane further comprises one or more minor stems coupled to in parallel with the stem, wherein the stem and the minor stems are pulled apart from each other to turn into a tripod to support the hybrid selfie cane.

13. A method comprising:
coupling a selfie stick with a cane, wherein the hybrid selfie cane includes the selfie stick coupled to the cane.

14. The method of claim 13, further comprising placing a smart device in a device holder of the hybrid selfie cane, wherein the smart device includes a camera capable of taking images including still images or videos, and wherein the hybrid selfie cane when serving as the selfie stick holds the smart device to facilitate taking images, and wherein the selfie cane when serving as the cane offers support for a user to perform at least one of walking, hiking, climbing, and skiing using the hybrid selfie cane.

15. The method of claim 13, wherein the hybrid selfie cane comprises a stem having multiple segments, wherein the method comprises folding-in the multiple segments to turn the hybrid selfie cane to be used as the selfie stick or folding-out the multiple segments to turn the hybrid selfie cane to be used as the cane.

16. The method of claim 13, wherein the multiple segments are capable of being pushed into each other to turn the hybrid selfie cane to be used as the selfie stick or pulled out of each other to turn the hybrid selfie cane to be used as the cane.

17. The method of claim 13, wherein the multiple segments possess fitting rings or magnets at one or more ends, wherein the multiple segments are joined together or separated from each other using the fitting rings or the magnets to turn the hybrid selfie cane to be used as the selfie stick or pulled out of each other to turn the hybrid selfie cane to be used as the cane, respectively.

18. The method of claim 13, wherein the hybrid selfie cane further comprises one or more minor stems coupled to in parallel with the stem, wherein the stem and the minor stems are pulled apart from each other to turn into a tripod to support the hybrid selfie cane.
